(19) United States
(12) Patent Application Publication
(10) Pub. No.: US 2001/0053378 A1
(43) Pub. Date: Dec. 20, 2001

(54) ANTIVIRAL FUMARIC ACID COMPOSITION

(76) Inventor: JOHN CHILAKOS, MOORPARK, CA (US)

Correspondence Address: TROJAN LAW OFFICES, 9250 WILSHIRE BLVD, SUITE 325, BEVERLY HILLS, CA, 90212

(21) Appl. No.: 09/235,026

(22) Filed: Jan. 20, 1999

(51) Int. Cl. A01N 25/00

(52) U.S. Cl. 424/405

(57) ABSTRACT

A composition and method for producing the composition, which is effective as a virucide and a bactericide, yet safe and non-irritating to human skin. The compositions include fumaric acid, benzoic acid and “IRGASAN® DP 300” as the active ingredients, and can also include denatured ethyl alcohol.

### RELATED PATENTS

U.S. Pat. No. 4,283,421 Ray Aug. 11, 1981

U.S. Pat. No. 4,523,589 Krauser Jun. 18, 1985

U.S. Pat. No. 4,828,912 Hossain et. al. May 9, 1989

U.S. Pat. No. 4,895,727 Allen Jan. 23, 1990

U.S. Pat. No. 4,897,304 Hossain et. al. Jan. 30, 1990

U.S. Pat. No. 4,946,868 Demarne et. al. Aug. 7, 1990

U.S. Pat. No. 4,975,217 Brown-Skrobot Dec. 4, 1990

U.S. Pat. No. 5,314,689 Scandurra et. al. May 24, 1994

U.S. Pat. No. 5,462,728 Blank et. al. Oct. 31, 1995

U.S. Pat. No. 5,580,549 Fukuda et. al. Dec. 3, 1996

### BACKGROUND OF THE INVENTION

1. Field of the Invention

This invention relates generally to a class of compositions which kill bacteria and viruses. Specifically this invention relates to long acting compositions which are bactericidal and virucidal.

2. Description of Related Art

The causes of the “common cold” and the “flu” have long been the focus of research. Rhinoviruses are thought to be the principle cause of common cold, while parainfluenza viruses the cause of the flu. Also being researched is a cure or means for preventing infection from these types of viruses.

Although efforts to cure a person infected with these viruses have not been successful, many different types of compositions have been created to prevent transmission of the viruses. Transmission can occur through direct or indirect contact with the viruses—direct contact is touching another person infected with the virus and indirect contact is touching a surface that an infected person has recently touched. Generally this contact occurs hand-to-hand or surface-to-hand.

(a) Surface—The majority of products developed to prevent surface-to-hand transmission treat the surface contaminated with viruses. This is because the virucidal compounds created were not safe for use on the human skin. Therefore, unless the contaminated surface is treated with a virucidal product a person who touches the contaminated surface may become infected by the virus.

Further, outside of a persons home, it is generally unknown to that person whether or not a particular surface has be cleaned with a virucidal product. Also, the virucidal effects of these surface products are temporary. Temporary in the sense that they only inactivate the viruses which are currently present on the surface, not viruses introduced some time after.

Thus treating the surface against viruses is not sufficient to prevent transmission of these viruses for the reasons just discussed. As a result, other products have been developed that can be used on the human skin and, therefore, can inactivate the viruses on the hand instead of the surface.

(b) Hands—Iodine can be applied to the human skin, and is a very effective virucide, but it is also very irritating to the skin. Thus a desirable formulation would be one that had sufficient virucidal capabilities and was also not irritating to the skin. U.S. Pat. No. 4,975,217 is a closely related patent of a composition which is effective against viruses and is more tolerable to the skin than iodine. That patent discloses a virucidal composition consisting of an organic acid and a alkyl sulfonate salt (a surfactant), for direct application to human skin.

The problems still present even in this composition are skin irritation and the small duration of efficacy as a virucide. Organic acids can exfoliate the skin, some more than others, which causes irritation. When a surfactant is combined with an organic acid there is an increase in penetration by the acid to the skin, therefore, further increasing the irritation to the skin. The effective duration of this product is much like the products developed for surfaces in that they inactivate the viruses presently on the skin, not the viruses that come into contact with the skin at a time after application.

From the preceding descriptions, it is apparent that the formulations currently being used have significant disadvantages. Thus important aspects of the technology used in the field of invention remain amenable to useful refinement.

### SUMMARY OF THE INVENTION

The present invention introduces such refinement. In it's first preferred embodiment, the invention is a composition for application to human skin which consists essentially of fumaric acid, benzoic acid, “IRGASAN® DP 300” (2,4,4′-trichloro-2′-hydroxydiphenyl ether, having a non-proprietary name of triclosan), and some non-aqueous vehicle for administering the composition directly to the skin. The fumaric acid, benzoic acid and “IRGASAN® DP 300” all have sufficient concentrations to render the composition effective against viruses and bacteria.

This formulation creates a virucidal and bactericidal composition which is safe and non-irritating to the skin. This benefit is a result of an overall reduction in the amount of active ingredient necessary to render the composition effective, as compared to previous compositions.

Fumaric acid is a very simple organic acid which is surprisingly non-irritating to human skin, yet effective against viruses at low concentrations. Combining the fumaric acid with the benzoic acid has a synergistic effect which creates a very effective virucide, and “IRGASAN® DP 300” renders the composition effective as an antimicrobial, which means it inactivates bacteria, fungi and yeasts. The combination of the three creates a composition which inactivates a broad spectrum of germs.

Although these formulations of the composition in their broad form represents a significant advance in the art, they are preferably practiced in conjunction with certain other compounds that further enhance enjoyment of this invention.

For example, it is preferred that the formula include ethyl alcohol, having a variable concentration depending on the concentration of the other ingredient, but generally a concentration of about 84% by weight. The ethyl alcohol is used as a solubilizer in the composition. As long as the concentration of the ethyl alcohol is greater than 70%, it also has the effect of an active ingredient, although it is transient. This means that when the composition is applied to skin the ethyl alcohol will initially inactivate viruses as well as bacteria, however, the alcohol will quickly evaporate, and thus its function as an active ingredient is transient.

It is also preferred that the concentration of the fumaric acid is between about 2% by weight and about 3% by weight, the concentration of the benzoic acid is between about 0.1% by weight and about 0.5% by weight, and the concentration of the “IRGASAN® DP 300” is between about 0.1% by weight and about 0.5% by weight.

The formula may also include “KLUCEL MF” (hydroxypropylcellulose), “DERMACRYL®-79” (hydrophobic, high molecular weight, carboxylated acrylic copolymer), isostearyl alcohol, “ELEFAC® I-205” (Octyldodecyl Neopentanoate), and fragrance. The concentration of the “KLUCEL MF” is between about 0.75% by weight and about 2% by weight, the concentration of the “DERMACRYL®-79” is between about 1% by weight and about 2% by weight, the concentration of the isostearyl alcohol is between about 7% by weigh and about 12% by weight, and the concentration of the “ELEFAC® I-205” is between about 2% by weight and about 5% by weight.

“ELEFAC® I-205” is an emollient which moisturizes and protects the skin, and by including it in the composition it significantly reduced the tackiness which occurred in trial formulas.

“KLUCEL MF” gels the mixture, making it easy to apply to the entire area of skin for which protection is desired. If a product is too thin then it is difficult to apply with sufficient coverage.

“DERMACRYL®-79” and the isostearyl alcohol reduce the possibility of irritation to the skin. This is because the “DERMACRYL®-79” and the isostearyl alcohol repel moisture, and repelling moisture is important because when an acid, such as fumaric acid, reacts with water it generates a compound which irritates the skin. Therefore, this formula is reduces possible skin irritation commonly associated with acids because moisture is repelled, preventing this reaction from occurring.

The isostearyl alcohol is also important because it becomes the solubilizer for the composition after the ethyl alcohol evaporates. The isostearyl alcohol as the solubilizer extends the effective duration of the composition as a germicide because it is non-aqueous and will not be affected by water or perspiration.

The benefits of this composition are numerous. The composition, having a gelled consistency can be easily and effectively applied to a person's skin. Also, the composition, once applied to the skin, forms a protective barrier which has long lasting virucidal and bactericidal effects. Further, because the composition is water repellent, placing skin treated with the composition under water will not remove or otherwise interfere with the composition or its ability to inactivate germs.

As discussed in the prior art section above, treating surfaces with a germicide has limitations, treating the skin (i.e. hands) is much more effective, since hands are the number one culprit in transmission of the viruses. Therefore, it is especially beneficial to inactivate the viruses here on the hands. Lastly, it must be remembered that this composition is also very gentle to skin allowing a person to wear it for a significant period of time without irritation.

Use of this composition is not limited to the hands. The composition is safe to use on skin in general and can even be used on the lips.

In it's second preferred embodiment the invention is a method for preparation of a germicidal composition. The method comprises the steps of heating denatured ethyl alcohol to a temperature having a range from 27-30° C., to increase its capabilities as a solvent. The next steps require dissolving fumaric acid into the denatured ethyl alcohol, dissolving benzoic acid into the denatured ethyl alcohol, and dissolving “IRGASAN® DP 300” into the denatured ethyl alcohol. The next step includes adding “KLUCEL MF” while mixing continuously until mixture is clear and semi-gel is obtained.

Further, dissolving “DERMACRYL®-79” into the mixture, then adding the isostearyl alcohol to the resulting mixture.

Although this method for preparation of a composition in its broad form represents a significant advance in the art, it is preferably practiced in conjunction with certain other steps that further enhance the enjoyment of the invention.

It is preferred that the method further include the steps of combining, in another vessel, isostearyl alcohol and “ELEFAC® I-205”, at room temperature using light mixing for approximately five minutes, then adding the two mixtures together with high-speed mixing for approximately five to ten minutes.

### DESCRIPTION OF THE PREFERRED EMBODIMENTS

While the invention will be described in connection with preferred embodiments, it will be understood that it is not intended to limit the invention to those embodiments. On the contrary, it is intended to cover all alternatives, modifications, and equivalents as may be included within the spirit and scope of the invention as defined by the appended claims.

The present invention is known to be effective for inactivation of Parainfluenza Type 3 and Rhino type 2 Virus. The composition has three main active ingredients fumaric acid, benzoic acid, and “IRGASAN® DP 300”. The denatured ethyl alcohol is a another active ingredient that is transient in its effectiveness.

A preferred embodiment of my invention has the formula:

| Ingredient | % by weight |
|---|---|
| denatured ethyl alcohol SDA-40-2 | 84.0 |
| fumaric acid U.S.P. | 3.0 |
| benzoic acid U.S.P. | 0.2 |
| “IRGASAN ® DP 300” | 0.3 |
| “KLUCEL MF” | 1.0 |
| “DERMACRYL ®-79” | 1.0 |
| isostearyl alcohol | 8.0 |
| “ELEFAC ® I-205” | 2.0 |
| fragrance | 0.5 |
| | 100.0 |

As the concentration of any of the ingredients is altered the concentration of the ethyl alcohol should be modified to compensate for the alteration to the composition. The fumaric acid can have a concentration between about 2% by weight to about 3% by weight, anything greater than 3% by weight has a tendency to precipitate out of solution. Benzoic acid can have a concentration between about 0.1% by weight to about 0.5% by weight, any concentration greater than 0.5% by weight the composition tends to becomes irritating to the skin.

The concentration of the “IRGASAN® DP 300” is between about 0.1% by weight and about 0.5% by weight, the concentration of the “KLUCEL MF” is between about 0.75% by weight and about 2% by weight, the concentration of the “DERMACRYL®-79” is between about 1% by weight and about 2% by weight, the concentration of the isostearyl alcohol is between about 7% by weigh and about 12% by weight, and the concentration of the “ELEFAC® I-205” is between about 2% by weight and about 5% by weight.

Another preferred embodiment of my invention includes a method for preparation of the germicidal composition. The method includes several steps:

heating denatured ethyl alcohol to a temperature having a range from 27-30° to increase its capability as a solvent;

dissolving fumaric acid into the denatured ethyl alcohol;

dissolving benzoic acid into the denatured ethyl alcohol;

dissolving “IRGASAN® DP 300” into the denatured ethyl alcohol;

adding “KLUCEL MF” while mixing continuously until mixture is clear and semi-gel is obtained;

dissolving “DERMACRYL®-79” into the resulting mixture;

combining together in another vessel, isostearyl alcohol and “ELEFAC® I-205” at room temperature using light mixing for approximately five minutes; and

adding to the two mixtures together at high-speed mixing for approximately five to ten minutes.

“KLUCEL MF” is to be added after the fumaric acid, benzoic acid and “IRGASAN® DP 300”. This is important because “KLUCEL MF” is a compound which gels the mixture, and thus it is difficult to dissolve the aforementioned ingredients if the “KLUCEL MF” is added first.

### IN-VITRO EXPERIMENTS

I. Materials

Compounds: The present composition, SDA Alcohol 40-2 representing the base solvent used for putting the composition into solution.

Cells and Viruses: A human carcinoma of the lung cell line, A-549 cells (American Type Culture Collection, (ATCC); Mannassas, Va.), was used to propagate rhino type 2 virus (strain HGP, ATCC) as well to titer the virus. Embryonic African green monkey cells (MA-104 cells, Biowhittaker, Inc.; Walkersville, Md.) were used to propagate and titer parainfluenza type 3 virus (strain C243, ATCC). The cells were grown in minimal essential medium (MEM, Gibco-BRL, Gaithersburg, Md.) supplemented with 0.1% NaHCO³ and 10% fetal bovine serum (FBS, Hyclone Laboratories, Logan, Utah). When titering the viruses in the cell lines, serum was reduced to 2% and 50 μg/ml gentamicin (Sigma Chemical Company, St. Louis, Mo.) was added to the medium.

II. Methods

A plastic petri dish was evenly coated with the composition at 2.0 mg/cm² from side to side as the plate was rotated at a tilted angle. Another plate was coated with the alcohol base (2.0 mg/cm²) in the same manner. A third petri was not coated. The two liquids were allowed to air dry for 30 minutes, 8 hours, or 3 days in their respective plates. Virus lysates, diluted by a factor of two in minimal essential medium (MEM), were then added to each plate, including the plate receiving no chemical. Enough volume was added to cover the surface of the plate. The time of virus exposure to the plate surfaces was 5 minutes at room temperature. Samples of virus lysate were removed and surviving virus was assayed by cytopathic effect assay (CPE) assay in MA-104 cells.

III. Results

Treatment with the composition dried for 30 minutes resulted in complete inactivation of parainfluenza virus and rhinovirus (Table 1). When the composition was dried for 8 hours or 3 days, both viruses were almost completely inactivated. At these two drying times, virus cytopatic effect was only detected in one well of the first dilution when either virus lysate was assayed for infectious particles following exposure to the composition. There was some apparent cytotoxicity detected in cells receiving virus and the composition in the first two dilutions when the compound was only air dried for 30 minutes. This cytotoxicity was visually different from the virus cytopathic when observed by light microscopy. It was not detected after the 8 hour or three-day exposure to air. The composition was found to have potent virucidal activity against an enveloped virus, parainfluenza virus, even after a three-day “drying” time of the composition.

TABLE 1
Inactivation of parainfluenza 3 and rhino type 2 viruses after
exposure to the composition air dried for various lengths of time

| | 30 min | 8 hour | 3 day |
|---|---|---|---|
| | air exposure | air exposure | air exposure |
| | Percent Reduction | Percent Reduction | Percent Reduction |
| Treatment | of Virus Titer | of Virus Titer | of Virus Titer |
| Parainfluenza | | | |
| 3 virus | | | |
| The | 100 | >99.9 | >99.9 |
| composition | | | |
| SDA 40-2^{a} | 0 | 0 | 0 |
| None^{b} | 0 | 0 | 0 |
| Rhino type | | | |
| 2 virus | | | |
| The | 100 | >99.9 | >99.9 |
| composition | | | |
| SDA 40-2^{a} | 0 | 0 | 0 |
| None^{b} | 0 | 0 | 0 |

^{a}SDA 40-2 = SDA alcohol 40-2, the solvent base.
^{b}None refers to the plate that received no liquid treatment.

I claim:

1. A composition for application to human skin consisting essentially of:
fumaric acid;
benzoic acid;
triclosan; and
a non-aqueous vehicle for administering the composition directly to the skin; and
the fumaric acid, benzoic acid and triclosan having sufficient concentrations to render the composition effective against viruses and bacteria.

2. The composition of claim 1, further comprising ethyl alcohol as a solubilizer and a transient active ingredient.

3. The composition of claim 1, wherein the concentration of the fumaric acid is between about 2% by weight and about 3% by weight.

4. The composition of claim 1, wherein the concentration of the benzoic acid is between about 0.1% by weight and about 0.5% by weight.

5. The composition of claim 1, wherein the concentration of the triclosan is between about 0.1% by weight and about 0.5% by weight.

6. The composition of claim 1, wherein the fumaric acid, benzoic acid and triclosan are the only active ingredients in the composition.

7. The composition of claim 1, wherein the non-aqueous vehicle comprises hydroxypropylcellulose, carboxylated acrylic copolymer, isostearyl alcohol, and octyldodecyl neopentanoate.

8. The composition of claim 7, wherein the concentration of the hydroxypropylcellulose is between about 0.75% by weight and about 2% by weight.

9. The composition of claim 7, wherein the concentration of the carboxylated acrylic copolymer is between about 1% by weight and about 2% by weight.

10. The composition of claim 7, wherein the concentration of the isostearyl alcohol is between about 7% by weight and about 12% by weight.

11. The composition of claim 7, wherein the concentration of the octyldodecyl neopentanoate is between about 2% by weight and about 5% by weight.

12. A method for preparation of a germicidal composition, said method comprising the steps of:
dissolving fumaric acid into denatured ethyl alcohol;
dissolving benzoic acid into the denatured ethyl alcohol;
dissolving triclosan into the denatured ethyl alcohol;
adding hydroxypropylcellulose while mixing continuously until mixture is clear and semi-gel is obtained;
dissolving carboxylated acrylic copolymer into the mixture; and
adding isostearyl alcohol to the resulting mixture.

13. The method of claim 12, further comprising the steps of
combining together in another vessel, isostearyl alcohol and octyldodecyl neopentanoate at room temperature using light mixing for approximately five minutes; and
adding the isostearyl alcohol mixture together with the resulting mixture with high-speed mixing for approximately five to ten minutes.
